(19) United States
(12) Patent Application Publication
(10) Pub. No.: US 2024/0323790 A1
(43) Pub. Date: Sep. 26, 2024

(54) METHODS AND APPARATUS FOR SENDING REQUEST AND DETERMINING BASE STATION

(71) Applicant: BEIJING XIAOMI MOBILE SOFTWARE CO., LTD., Beijing (CN)

(72) Inventors: Qin MU, Beijing (CN); Wei HONG, Beijing (CN); Zhongyuan ZHAO, Beijing (CN); Kexin XIONG, Beijing (CN)

(73) Assignee: BEIJING XIAOMI MOBILE SOFTWARE CO., LTD., Beijing (CN)

(21) Appl. No.: 18/577,988

(22) PCT Filed: Jul. 9, 2021
(86) PCT No.: PCT/CN2021/105584

§ 371 Date: Jan. 9, 2024

(51) Int. Cl. H04W 36/30; H04W 36/08

(52) U.S. Cl. CPC H04W 36/30; H04W 36/08

(57) ABSTRACT

A method for sending a request is performed by a terminal and includes: determining a first next generation node B (gNB) accessible, when initiating an analysis subscription request, and in response to a currently accessed base station being a next generation eNodeB (ng-eNB); and handing over to the first gNB, and sending the analysis subscription request to the first gNB.

### CROSS-REFERENCE TO RELATED APPLICATION

This application is a U.S. national phase application of International Application No. PCT/CN2021/105584, filed on Jul. 9, 2021, the entire disclosure of which is incorporated herein by reference for all purposes.

### TECHNICAL FIELD

The present disclosure generally relates to the technical field of communication, and more particularly, to a method for sending a request, a method for determining a base station, a device for sending a request, a device for determining a base station, a communication device, and a non-transitory computer-readable storage medium.

### BACKGROUND

There are mainly two 5th generation (5G) network modes, one is a standalone network, and the other one is a non-standalone network. The non-standalone network further includes multiple series, with the current focus on the series 3 and series 4 (also known as option 3 and option 4). In the series 4, a 5G base station (also called a next generation node B, gNB) serves as an anchor base station, a core network is a 5G core network, in combination with an enhanced 4G base station (also called a next generation eNodeB, ng-eNB) for networking. This network mode may be called a New Radio (NR) eNB dual connection (NE-DC).

The network in this mode includes two types of base stations, i.e., gNB and ng-eNB. Because these two types of base stations have different capabilities, some problems will occur in the information processing procedure.

### SUMMARY

According to a first aspect of embodiments of the present disclosure, there is provided a method for sending a request, which is performed by a terminal and includes: determining a first next generation node B (gNB) accessible, when initiating an analysis subscription request, and in response to a currently accessed base station being a next generation eNodeB (ng-eNB); and handing over to the first gNB, and sending the analysis subscription request to the first gNB.

According to a second aspect of embodiments of the present disclosure, there is provided a method for determining a base station, which is performed by an operation administration and maintenance (OAM) and includes: receiving an analysis subscription request sent by a next generation eNodeB (ng-eNB), and determining a second next generation node B (gNB) capable of performing data analysis for the analysis subscription request; determining the second gNB; and sending data analysis configuration information to the second gNB and the ng-eNB. The data analysis configuration information is used to indicate that an analysis result for the analysis subscription request is to be sent by the second gNB to the ng-eNB.

According to a third aspect of embodiments of the present disclosure, there is provided a method for sending a request, which is performed by a next generation eNodeB (ng-eNB) and includes: sending an analysis subscription request, when initiated or received from a terminal, to an operation administration and maintenance (OAM) to request the OAM to determine a second next generation node B (gNB) capable of performing data analysis for the analysis subscription request; and receiving an analysis result for the analysis subscription request sent by the second gNB.

According to a fourth aspect of embodiments of the present disclosure, there is provided a device for sending a request, which includes: one or more processors, configured to: determine a first next generation node B (gNB) accessible, when initiating an analysis subscription request, and in response to a currently accessed base station being a next generation eNodeB (ng-eNB); and hand over to the first gNB, and send the analysis subscription request to the first gNB.

According to a fifth aspect of embodiments of the present disclosure, there is provided a device for determining a base station, which includes: one or more processors, configured to: receive an analysis subscription request sent by a next generation eNodeB (ng-eNB), and determine a second next generation node B (gNB) capable of performing data analysis for the analysis subscription request; determine the second gNB; and send data analysis configuration information to the second gNB and the ng-eNB. The data analysis configuration information is used to indicate that an analysis result for the analysis subscription request is to be sent by the second gNB to the ng-eNB.

According to a sixth aspect of embodiments of the present disclosure, there is provided a device for sending a request, which includes: one or more processors, configured to: send an analysis subscription request, when initiated or received from a terminal, to an operation administration and maintenance (OAM) to request the OAM to determine a second next generation node B (gNB) capable of performing data analysis for the analysis subscription request; and receive an analysis result for the analysis subscription request sent by the second gNB.

According to a seventh aspect of embodiments of the present disclosure, there is provided a communication device, which includes: a processor; and a memory for storing a computer program. When the computer program is executed by the processor, the above method for sending a request performed by the terminal is implemented.

According to an eighth aspect of embodiments of the present disclosure, there is provided a communication device, which includes: a processor; and a memory for storing a computer program. When the computer program is executed by the processor, the above method for determining a base station is implemented.

According to a ninth aspect of embodiments of the present disclosure, there is provided a communication device, which includes: a processor; and a memory for storing a computer program. When the computer program is executed by the processor, the above method for sending a request performed by the ng-eNB is implemented.

According to a tenth aspect of embodiments of the present disclosure, there is provided a non-transitory computer-readable storage medium having stored therein a computer program that, when executed by a processor, causes steps in the above method for sending a request performed by the terminal to be implemented.

According to an eleventh aspect of embodiments of the present disclosure, there is provided a non-transitory computer-readable storage medium having stored therein a computer program that, when executed by a processor, causes steps in the above method for determining a base station to be implemented.

According to a twelfth aspect of embodiments of the present disclosure, there is provided a non-transitory computer-readable storage medium having stored therein a computer program that, when executed by a processor, causes steps in the method for sending a request performed by the ng-eNB to be implemented.

### BRIEF DESCRIPTION OF THE DRAWINGS

The accompanying drawings of the present disclosure will be briefly introduced below.

FIG. 1 is a schematic flowchart showing a method for sending a request according to embodiments of the present disclosure.

FIG. 2 is a schematic diagram showing a network according to embodiments of the present disclosure.

FIG. 3 is a schematic flowchart showing a method for sending a request according to embodiments of the present disclosure.

FIG. 4 is a schematic flowchart showing a method for determining a base station according to embodiments of the present disclosure.

FIG. 5 is a schematic flowchart showing a method for determining a base station according to embodiments of the present disclosure.

FIG. 6 is a schematic flowchart showing a method for determining a base station according to embodiments of the present disclosure.

FIG. 7 is a schematic flowchart showing a method for sending a request according to embodiments of the present disclosure.

FIG. 8 is a schematic flowchart showing a method for sending a request according to embodiments of the present disclosure.

FIG. 9 is a schematic flowchart showing a method for sending a request according to embodiments of the present disclosure.

FIG. 10 is a schematic diagram showing interactions when a gNB initiates an analysis subscription request according to embodiments of the present disclosure.

FIG. 11 is a schematic diagram showing interactions when an ng-eNB initiates an analysis subscription request according to embodiments of the present disclosure.

FIG. 12 is a schematic diagram showing interactions when a terminal initiates an analysis subscription request according to embodiments of the present disclosure.

FIG. 13 is a schematic diagram showing interactions when a terminal initiates an analysis subscription request according to embodiments of the present disclosure.

FIG. 14 is a schematic block diagram showing a device for sending a request according to embodiments of the present disclosure.

FIG. 15 is a schematic block diagram showing a device for sending a request according to embodiments of the present disclosure.

### DETAILED DESCRIPTION

Embodiments of the present disclosure will be described clearly and thoroughly below with reference to accompanying drawings. It should be understood that embodiments described herein are only some embodiments, rather than all embodiments of the present disclosure. All other embodiments obtained by those skilled in the art based on embodiments described herein without creative labors shall belong to the protection scope of the present disclosure.

Terms used in embodiments of the present disclosure are only for the purpose of describing specific embodiments, and not intended to limit embodiments of the present disclosure. As used in embodiments of the present disclosure and the appended claims, “a/an” and “the” in a singular form are intended to include plural forms, unless clearly indicated in the context otherwise. It should also be understood that, the term “and/or” used herein represents and includes any one or any possible combinations of one or more associated listed items.

It should be understood that even though terms such as “first,” “second,” and “third” may be used in embodiments of the present disclosure for describing various information, such information should not be limited by these terms. These terms are only used for distinguishing information of the same type from each other. For example, first information may also be referred to as second information, and similarly, the second information may also be referred to as the first information, without departing from the scope of embodiments of the present disclosure. Depending on the context, the term “if” as used herein may be construed to mean “when,” “upon,” or “in response to determining.”

For brevity and ease of understanding, terms “greater than” or “less than,” “higher than” or “lower than” are used herein for indicating size relationships. However, it may be understood for a person skilled in the art that the term “greater than” also covers a meaning of “greater than or equal to,” the term “less than” also covers a meaning of “less than or equal to”; the term “higher than” also covers a meaning of “higher than or equal to,” and the term “lower than” also covers a meaning of “lower than or equal to.”

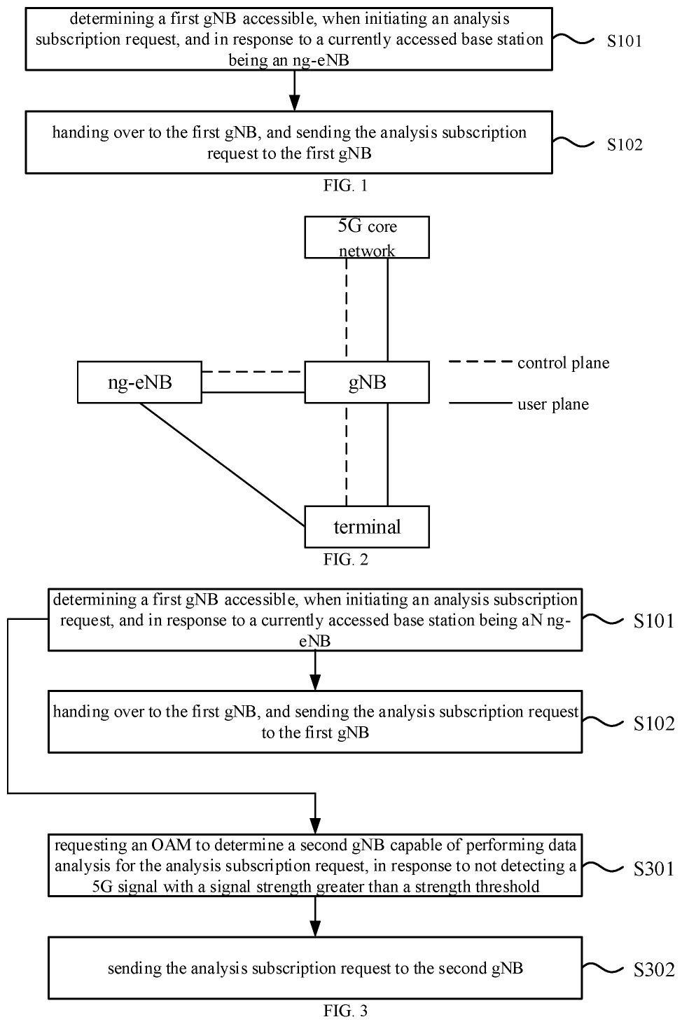

FIG. 1 is a schematic flowchart showing a method for sending a request according to embodiments of the present disclosure. The method for sending a request shown in these embodiments may be performed by a terminal, and the terminal includes, but is not limited to, a communication device such as a mobile phone, a tablet computer, a wearable device, a sensor, or an Internet of Things device. The terminal may serve as a user equipment to communicate with a base station, and the base station includes, but is not limited to, a 5G base station gNB and an enhanced 4G base station ng-eNB in series 4 of a non-standalone network mode.

As shown in FIG. 1, the method for sending a request may include the following steps.

In step S101, when an analysis subscription request is initiated, in response to a currently accessed base station being a next generation eNodeB (ng-eNB), a first next generation node B (gNB) accessible is determined.

In step S102, the first gNB is handed over to, and the analysis subscription request is sent to the first gNB.

In an embodiment, the analysis subscription request initiated by the terminal is mainly used to request a network device to perform data analysis on certain data based on a model obtained by machine learning (or deep learning) to obtain an analysis result, and feed the analysis result back to the terminal.

Various kinds of contents may be requested to be analyzed by the analysis subscription request. For example, the analysis subscription request may request to analyze a load of a certain network device. For example, the analysis subscription request may request to analyze whether a terminal needs to perform a cell handover. The contents requested to be analyzed are not limited to these examples, and may be selected as needed. Different models may be used to analyze different contents, or the same model may be used for data analysis on similar contents. Each transmission of the analysis subscription request may request to analyze an item of content or multiple items of contents, which is not limited in this disclosure.

FIG. 2 is a schematic diagram showing a network according to embodiments of the present disclosure.

As shown in FIG. 2, a network where the terminal is located includes a non-standalone network. For example, it may be a network mode of series 4, which takes a gNB as an anchor base station and a 5G core network as a core network, in combination with an ng-eNB network.

The terminal and the gNB may perform control plane communication and user plane communication, the terminal and the ng-eNB may perform user plane communication, the ng-eNB and the gNB may perform control plane communication and user plane communication, and the gNB may perform control plane communication and user plane communication with the 5G core network, and the ng-eNB does not communicate directly with the 5G core network. The control plane communication includes transmission of a scheduling signaling or a control signaling, and the user plane communication includes transmission of service data.

In an embodiment, when the terminal initiates an analysis subscription request, it may send the analysis subscription request to the currently accessed base station, so as to request the base station to perform data analysis based on a model. However, the base station currently accessed by the terminal may be a gNB or an ng-eNB. The gNB and the ng-eNB have different capabilities, for example, the gNB has the ability to perform data analysis based on a model, while the ng-eNB does not have the ability to perform data analysis based on a model. Therefore, when the terminal accesses different base stations, the analysis process will be different. In the following, these two cases will be illustrated respectively.

In an embodiment, when the base station currently accessed by the terminal is a gNB in an NR eNB dual connection (NE-DC), the analysis subscription request may be sent to the gNB in the NE-DC. Since the computing and processing capability of the gNB is relatively strong (stronger than that of the ng-eNB), it has a capability of data analysis based on a model. After receiving the analysis subscription request, the gNB may determine a content required to be analyzed by the analysis subscription request, and determine a model required for analyzing the content, called as for example a target model, and then determine whether the target model exists locally in the gNB.

If the target model exists locally in the gNB, the gNB may directly obtain data and input the data to the target model to obtain an analysis result, and feed the analysis result back to the terminal. If the target model does not exist locally in the gNB, the target model may be obtained from an operation administration and maintenance (OAM). For example, the analysis subscription request is sent to the OAM, and the OAM determines the target model according to the analysis subscription request and sends the target model to the gNB.

It should be noted that, in all embodiments of the present disclosure, such as the above-mentioned embodiments in which the terminal initiates the analysis subscription request, and the subsequent embodiments in which the gNB initiates the analysis subscription request and embodiments in which the ng-eNB initiates the analysis subscription request, the process of data analysis for the analysis subscription request may be the same (the difference lies in how to determine the gNB for data analysis), so the general process of the data analysis is mainly described here, which will not be elaborated in subsequent embodiments.

For example, the data analysis is performed by using the target model. Data is obtained as an input of the target model, and the obtained data may derive from any device in the network, such as from the core network, the gNB, the ng-eNB, or the terminal. In a non-terrestrial network, the data may also derive from a satellite. Further, the gNB may pre-process the obtained data, such as converting it into a vector form, for input into the target model.

For example, when the analysis subscription request is to request to analyze a load of a certain ng-eNB (for example, called base station A), the gNB may obtain information on its ongoing services, the number of accessed terminals, identifiers of the accessed terminals, and the like from the base station A, and may also obtain data volume of a service that needs to be transmitted in the communication between the terminal and the base station A and other data from terminals accessing the base station A.

For example, when the analysis subscription request is to request to analyze whether the terminal needs to perform a cell handover, the gNB may obtain terminal location information from the terminal and obtain signal quality information of base stations near the terminal, and use the obtained data as the input of the model.

The above description on the model input is only for example. In specific application of the model, the input is not limited to the data obtained above. Moreover, based on different analysis subscription requests, the model is not limited to analyzing the above contents.

It can be seen that when the terminal is currently accessed to the gNB, since the gNB is capable of performing data analysis based on a model, the analysis can be completed by the gNB according to a local model or a model obtained from the OAM. However, when the terminal is currently accessed to the ng-eNB, because the ng-eNB cannot perform data analysis based on a model, some problems will arise.

For example, the base station currently accessed by the terminal is the ng-eNB, and a current location of the terminal is not covered by 5G signals, so there is no gNB to provide a service for the terminal to perform data analysis for the analysis subscription request initiated by the terminal. Moreover, at present, even if the current location of the terminal is covered by 5G signals, the analysis subscription request initiated by the terminal will not trigger the terminal to actively detect 5G signals and hand over to a gNB, so the analysis subscription request initiated by the terminal still cannot be processed in time. Furthermore, even if the analysis subscription request initiated by the terminal is not processed in time, the terminal may still continue to initiate other analysis subscription requests, resulting in the accumulation of analysis subscription requests. When the terminal is accessed to a gNB subsequently, the terminal will send all the accumulated analysis subscription requests to the gNB, leading to a sharp increase in the load of the gNB, which causes adverse effects on the gNB.

According to embodiments of the present disclosure, when the terminal initiates the analysis subscription request, if the currently accessed base station is the ng-eNB, the terminal may be triggered to actively detect 5G signals, and hand over to a gNB process. The terminal may determine the first gNB accessible through a certain manner. For example, the terminal detects signal strengths of 5G signals, and determines a base station corresponding to a 5G signal with a signal strength greater than a strength threshold as the first gNB. After the first gNB is determined, the terminal may hand over to the first gNB, and send the analysis subscription request to the first gNB, so that the analysis subscription request is sent to the gNB capable of performing data analysis based on a model in time, to ensure that the analysis subscription request is processed in time.

In an embodiment, determining the first gNB accessible includes: detecting a signal strength of a received signal; and determining a base station corresponding to a 5G signal with a signal strength greater than a strength threshold as the first gNB.

The terminal may detect the signal strength of the received signal. For example, when the terminal determines that it is currently accessed to the ng-eNB, the terminal may receive signals in a 5G frequency band. For example, the terminal only receives signals in the 5G frequency band. If it is determined that there exists a 5G signal with a greater signal strength, for example than a strength threshold, a base station corresponding to the 5G signal may be determined as the first gNB, and the terminal hands over to the first gNB and sends the analysis subscription request to the first gNB, so that the first gNB completes the analysis for the analysis subscription request.

FIG. 3 is a schematic flowchart showing a method for sending a request according to embodiments of the present disclosure. As shown in FIG. 3, in an embodiment, the method further includes the following steps.

In step S301, if no 5G signal with a signal strength greater than a strength threshold is detected, an operation administration and maintenance (OAM) is requested to determine a second gNB that is capable of performing data analysis for the analysis subscription request.

In step S302, the analysis subscription request is sent to the second gNB.

In an embodiment, when the current location of the terminal is not covered by 5G signals, or even if it is covered by the 5G signals, the strength of the 5G signals is weak, for example, the strength of the 5G signals is less than or equal to the strength threshold, so it is difficult to ensure communication quality even if the terminal accesses to the 5G base station, in this case, the terminal can still maintain access to the ng-eNB and send a gNB determination request (which can carry the analysis subscription request) to the OAM via the ng-eNB, to request the OAM to determine the second gNB that is capable of performing data analysis for the analysis subscription request, and send the analysis subscription request to the second gNB, so that the second gNB can complete the analysis for the analysis subscription request.

The method for the OAM to determine the second gNB may be selected as required. For example, the second gNB that is capable of performing data analysis for the analysis subscription request may be determined from gNBs accessible by the terminal, or a gNB with a lower load is determined as the second gNB. The OAM sends the target model capable of performing data analysis for the analysis subscription request to the determined gNB. The specific manner will be specifically described in subsequent embodiments related to operations executed by the OAM.

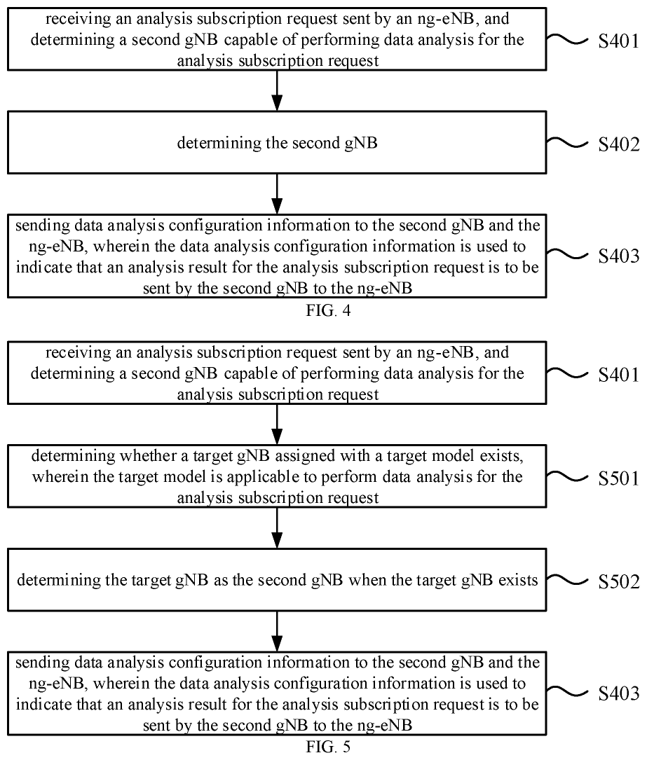

FIG. 4 is a schematic flowchart showing a method for determining a base station according to embodiments of the present disclosure. The method for determining a base station shown in embodiments of the present disclosure may be performed by an OAM, and the OAM can communicate with a base station in a network, for example, a gNB and an ng-eNB in the NE-DC, and the base station can communicate with a terminal. The terminal includes, but is not limited to, a communication device such as a mobile phone, a tablet computer, a wearable device, a sensor, or an Internet of Things device, and the base station includes, but is not limited to, a 5G base station gNB and an enhanced 4G base station ng-eNB in series 4 of a non-standalone network mode.

As shown in FIG. 4, the method for determining a base station may include the following steps.

In step S401, an analysis subscription request sent by an ng-eNB is received, and a second gNB capable of performing data analysis for the analysis subscription request is determined.

In step S402, the second gNB is determined.

In step S403, data analysis configuration information is sent to the second gNB and the ng-eNB. The data analysis configuration information is used to indicate that an analysis result for the analysis subscription request is to be sent by the second gNB to the ng-eNB.

In an embodiment, the analysis subscription request may be initiated by the ng-eNB, or may be initiated by a terminal accessing the ng-eNB and sent to the ng-eNB.

When the analysis subscription request is initiated by the terminal, the base station currently accessed by the terminal is an ng-eNB, and no 5G signal with a signal strength greater than a threshold is detected, the analysis subscription request may be sent to an OAM via the ng-eNB, to request the OAM to determine the second gNB that is capable of performing data analysis for the analysis subscription request.

When the analysis subscription request is initiated by the ng-eNB, since the ng-eNB cannot perform data analysis based on a model, it can send the analysis subscription request to the OAM to request the OAM to determine the second gNB that is capable of performing data analysis for the analysis subscription request.

After receiving the analysis subscription request, the OAM may determine the second gNB, and send the data analysis configuration information to both the determined gNB and the ng-eNB that sends the analysis subscription request, to indicate via the data analysis configuration information that the analysis result for the analysis subscription request is to be sent by the second gNB to the ng-eNB.

After receiving the data analysis configuration information sent by the OAM, the second gNB may send the analysis result for the analysis subscription request to the ng-eNB. After the ng-eNB receives the data analysis configuration information sent by the OAM, when the second gNB needs to obtain data for the data analysis, the ng-eNB may send the data required by the second gNB to the second gNB, and may also obtain data required by the second gNB from other base stations in the network and send it to the second gNB. Moreover, the ng-eNB can also receive the analysis result sent by the second gNB. When the analysis subscription request is initiated by the terminal, the ng-eNB can further send the analysis result to the terminal.

Accordingly, when the ng-eNB or the terminal accessing the ng-eNB initiates the analysis subscription request, the OAM may be requested to determine the second gNB, and the second gNB performs the data analysis for the analysis subscription request, and sends the obtained analysis result to the terminal or the ng-eNB, so as to ensure that the analysis subscription request is processed in time.

FIG. 5 is a schematic flowchart showing a method for determining a base station according to embodiments of the present disclosure. As shown in FIG. 5, determining the second gNB includes the following steps.

In step S501, it is determined whether a target gNB assigned with a target model exists. The target model is applicable to perform data analysis for the analysis subscription request.

In step S502, when the target gNB exists, the target gNB is determined as the second gNB.

In an embodiment, the OAM may first determine the target model applicable to perform data analysis for the analysis subscription request, and then determine whether the target gNB assigned with the target model exists. If the target gNB exists, the data analysis for the analysis subscription request can be completed by the target gNB, so that target gNB may be determined as the second gNB.

It should be noted that the condition to be considered for determining the target gNB includes, but is not limited to, whether a gNB is assigned with the target model. For example, whether signals of a gNB cover the current location of the terminal may also be considered, if the signals of the gNB cover the current location of the terminal, the gNB may be determined as the target gNB, so to ensure that the target gNB can be used as the second gNB to communicate with the terminal.

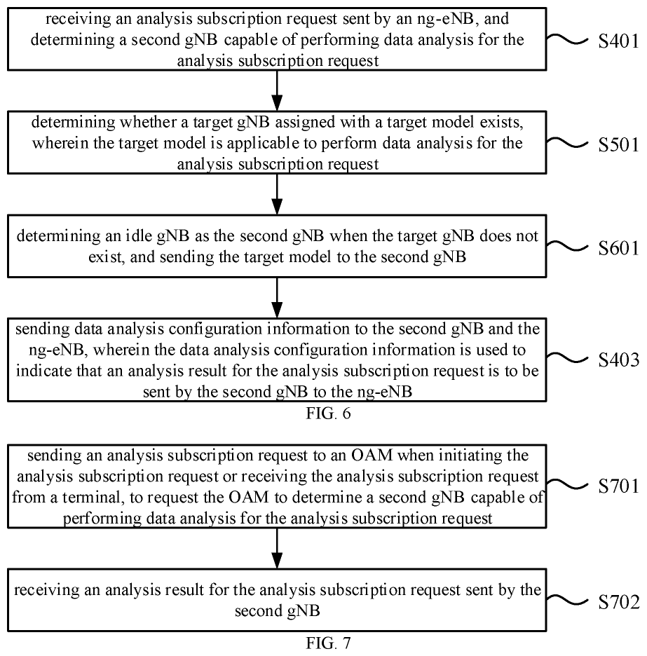

FIG. 6 is a schematic flowchart showing a method for determining a base station according to embodiments of the present disclosure. As shown in FIG. 6, the method further includes a following step.

In step S601, when the target gNB does not exist, an idle gNB is determined as the second gNB, and the target model is sent to the second gNB.

In an embodiment, the OAM may first determine the target model applicable to perform data analysis for the analysis subscription request, and then determine whether the target gNB assigned with the target model exists. If the target gNB does not exist, the OAM may determine the idle gNB as the second gNB, and send the target model to the second gNB, so that the determined second gNB can complete the data analysis for the analysis subscription request as soon as possible.

The idle gNB may be determined according to, but not limited to, a load of a gNB, the number of accessed terminals, etc. For example, a gNB with a load lower than a load threshold may be determined as the idle gNB, or a gNB with the number of accessed terminals less than a threshold may be determined as the idle gNB.

FIG. 7 is a schematic flowchart showing a method for sending a request according to embodiments of the present disclosure. The method for sending a request shown in these embodiments of the present disclosure may be performed by a base station ng-eNB in an NE-DC, and the ng-eNB can communicate with a terminal and an OAM. The terminal includes, but is not limited to, a communication device such as a mobile phone, a tablet computer, a wearable device, a sensor, or an Internet of Things device.

As shown in FIG. 7, the method for sending a request may include the following steps.

In step S701, an analysis subscription request is sent to an OAM when initiating the analysis subscription request or receiving the analysis subscription request from a terminal, to request the OAM to determine a second gNB capable of performing data analysis for the analysis subscription request.

In step S702, an analysis result for the analysis subscription request sent by the second gNB is received.

In an embodiment, when the terminal initiates the analysis subscription request, if a base station currently accessed by the terminal is an ng-eNB, and no 5G signal with a signal strength greater than a strength threshold is detected, the analysis subscription request may be sent to the OAM via the ng-eNB, to request the OAM to determine the second gNB capable of performing data analysis for the analysis subscription request.

When an ng-eNB itself initiates the analysis subscription request, since the ng-eNB cannot perform data analysis based on a model, it can send the analysis subscription request to the OAM to request the OAM to determine the second gNB that is capable of performing data analysis for the analysis subscription request.

After receiving the analysis subscription request, the OAM may determine the second gNB, and send data analysis configuration information to both the determined gNB and the ng-eNB that sends the analysis subscription request, to indicate via the data analysis configuration information that an analysis result for the analysis subscription request is to be sent by the second gNB to the ng-eNB.

After receiving the data analysis configuration information sent by the OAM, the second gNB may send the analysis result for the analysis subscription request to the ng-eNB. After the ng-eNB receives the data analysis configuration information sent by the OAM, the ng-eNB may receive the analysis result sent by the gNB. When the analysis subscription request is initiated by the terminal, the ng-eNB can further send the analysis result to the terminal.

Accordingly, when the terminal or the ng-eNB initiates the analysis subscription request, the OAM may be requested to determine the second gNB, and the second gNB performs the data analysis for the analysis subscription request, and sends the obtained analysis result to the terminal or the ng-eNB, so as to ensure that the analysis subscription request is processed in time.

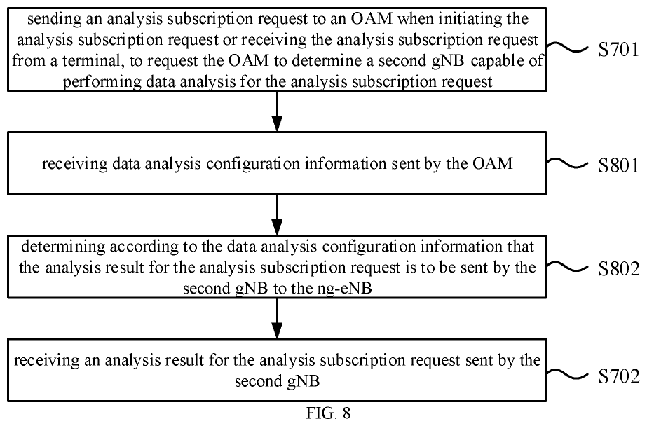

FIG. 8 is a schematic flowchart showing a method for sending a request according to embodiments of the present disclosure. As shown in FIG. 8, before receiving the analysis result for the analysis subscription request sent by the second gNB, the method further includes the following steps.

In step S801, data analysis configuration information sent by the OAM is received.

In step S802, it is determined according to the data analysis configuration information that the analysis result for the analysis subscription request is to be sent by the second gNB to the ng-eNB.

In an embodiment, after determining the second gNB, the OAM may send the data analysis configuration information to the second gNB and the ng-eNB, to indicate the ng-eNB via the data analysis configuration information that the data analysis for the analysis subscription request will be performed subsequently by the second gNB, so that the ng-eNB may receive the analysis result sent by the second gNB; and correspondingly, according to the data analysis configuration information, the second gNB determines that the analysis result needs to be sent to the ng-eNB.

For example, the ng-eNB may establish an inter-base station interface with the second gNB, and receive the analysis result from the second gNB through the inter-base station interface.

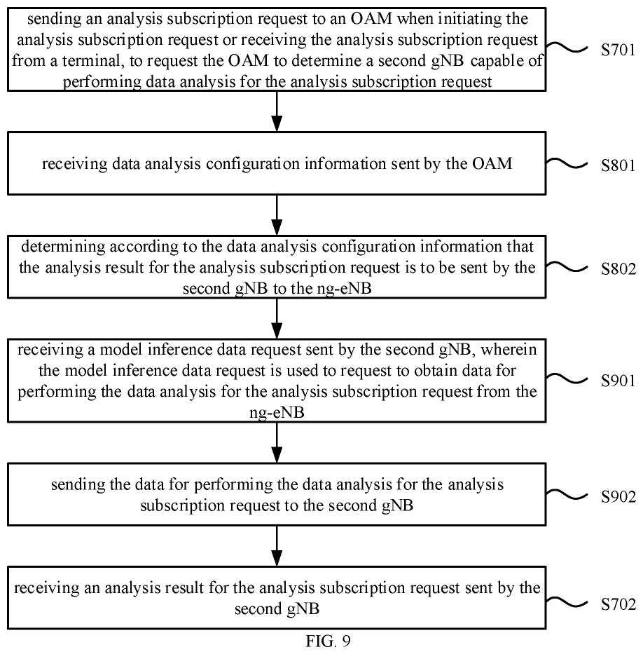

FIG. 9 is a schematic flowchart showing a method for sending a request according to embodiments of the present disclosure. As shown in FIG. 9, the method further includes the following steps.

In step S901, a model inference data request sent by the second gNB is received. The model inference data request is used to request to obtain data for performing the data analysis for the analysis subscription request from the ng-eNB.

In step S902, the data for performing the data analysis for the analysis subscription request is sent to the second gNB.

In an embodiment, after determining the second gNB, the OAM may send the data analysis configuration information to the second gNB and the ng-eNB, to indicate the ng-eNB via the data analysis configuration information that the data analysis for the analysis subscription request will be performed subsequently by the second gNB, so that when the second gNB needs to obtain data from the ng-eNB for performing the data analysis, the ng-eNB may send the data required by the second gNB to the second gNB, and may also obtain data required by the second gNB from other base stations in the network and send it to the second gNB.

In an embodiment, the gNB may also initiate the analysis subscription request. After the gNB initiates the analysis subscription request, the target model to be used for performing the data analysis for the analysis subscription request may be determined. If the target model exists locally in the gNB, the target model may be used directly to perform the data analysis. If the target model does not exist locally in the gNB, a request may be sent to the OAM to obtain the target model from the OAM to perform the data analysis.

The above embodiments mainly involve the following four situations, namely: the terminal initiates the analysis subscription request, and the terminal is currently accessed to the gNB; the terminal initiates the analysis subscription request, and the terminal is currently accessed to the ng-eNB; the ng-eNB initiates the analysis subscription request; and the gNB initiates the analytics subscription request. In the following, these four situations will be described respectively with reference to schematic interaction diagrams.

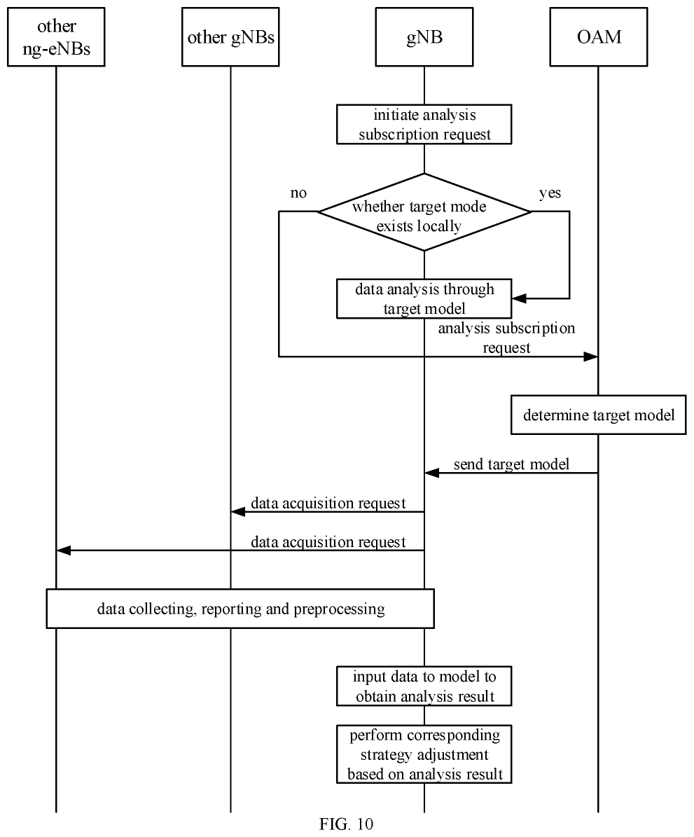

FIG. 10 is a schematic diagram showing interactions when a gNB initiates an analysis subscription request according to embodiments of the present disclosure.

As shown in FIG. 10, when the gNB initiates the analysis subscription request, it can determine the target model used for data analysis according to the content to be analyzed for the analysis subscription request, and then query whether the target model exists locally.

If the target model exists locally, the data analysis can be performed directly through the target model to obtain an analysis result. If the target model does not exist locally, the analysis subscription request may be sent to the OAM, and the OAM may determine the target model for the data analysis according to the content to be analyzed for the analysis subscription request, and then send the target model to the gNB.

In order to perform the data analysis, the gNB may obtain data from other base stations as the input of the target model. For example, the gNB may send a data acquisition request to other gNBs and other ng-eNBs in the network, and other base stations may send the data required by the gNB to the gNB. The process includes operations like that the gNB collects data, other base stations report data to the gNB, and the gNB preprocesses the data, etc.

Furthermore, the gNB may input the obtained data into the target model to obtain an analysis result, and then perform a corresponding strategy adjustment according to the analysis result. For example, the content to be analyzed for the analysis subscription request is to determine a target base station suitable for the terminal to be handed over to, and the target base station may be determined according to the analysis result, then the strategy adjustment to be performed may be to send an indication to the terminal to indicate the terminal to hand over to the target base station.

It should be noted that, in all embodiments of the present disclosure, other gNBs refer to one or more gNBs, and other ng-eNBs refer to one or more ng-eNBs.

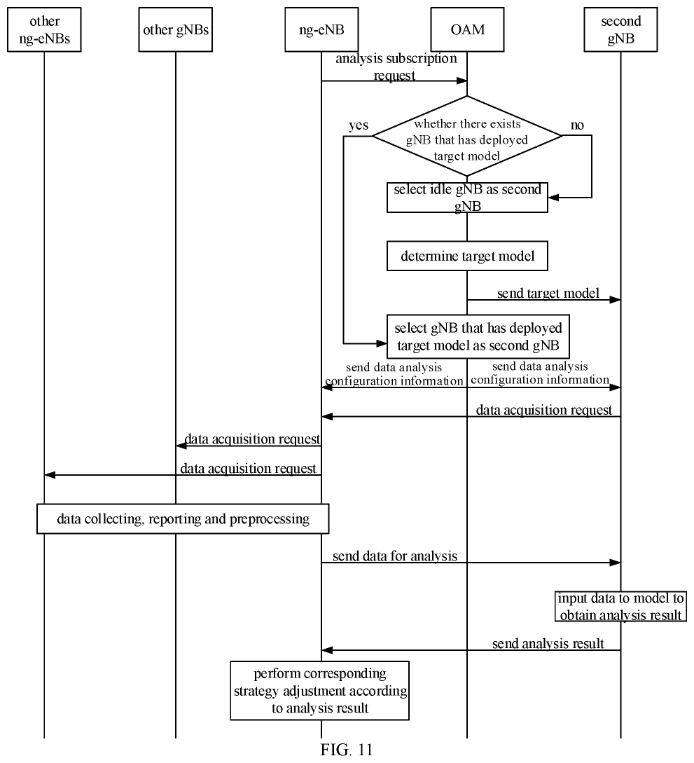

FIG. 11 is a schematic diagram showing interactions when an ng-eNB initiates an analysis subscription request according to embodiments of the present disclosure.

As shown in FIG. 11, when the ng-eNB initiates the analysis subscription request, since the ng-eNB is not capable of performing data analysis based on a model, it may send the analysis subscription request to an OAM directly or via an adjacent gNB. After receiving the analysis subscription request, the OAM may determine the target model for data analysis according to the content to be analyzed for the analysis subscription request, and then determine whether there exists a gNB that has deployed the target model.

If there is no gNB that has deployed the target model, an idle gNB may be selected as the second gNB, and the target model may be sent to the second gNB. If there exists the gNB that has deployed the target model, the gNB may be directly used as the second gNB. Further, the OAM may send data analysis configuration information to both the ng-eNB and the second gNB, to indicate that the data analysis will be performed by the second gNB subsequently.

In order to perform the data analysis, the second gNB may obtain data from other base stations as the input of the target model. For example, the second gNB may send a data acquisition request to the ng-eNB that initiates the analysis subscription request, other gNBs and other ng-eNB in the network, and these base stations may send data required by the second gNB to the second gNB. This process includes operations like that the second gNB collects data, the base station reports data to the second gNB, and the second gNB preprocesses the data.

Furthermore, the second gNB may input the obtained data into the target model to obtain an analysis result, and send the analysis result to the ng-eNB that initiates the analysis subscription request. The ng-eNB may perform a corresponding strategy adjustment according to the analysis result. For example, the content to be analyzed for the analysis subscription request is to determine a target base station suitable for the terminal to be handed over to, and the target base station may be determined according to the analysis result, then the strategy adjustment to be performed may be to send an indication to the terminal to indicate the terminal to hand over to the target base station.

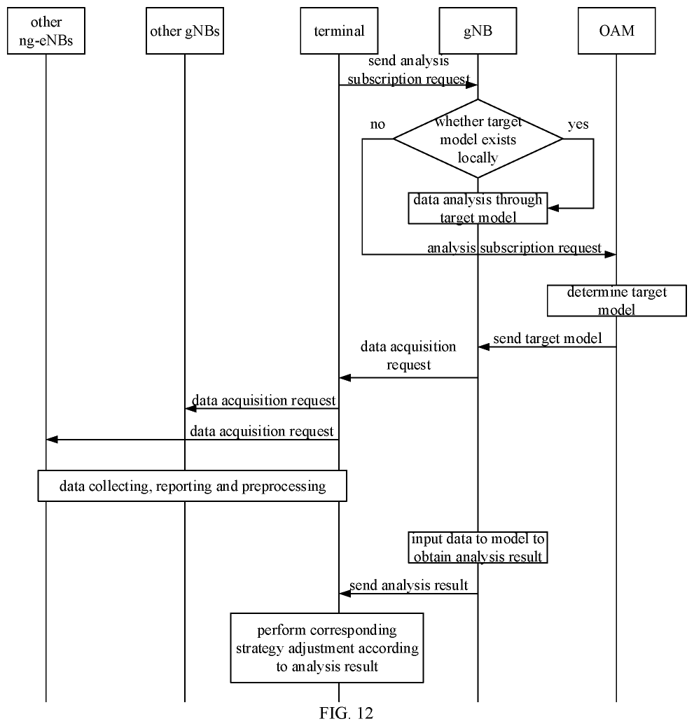

FIG. 12 is a schematic diagram showing interactions when a terminal initiates an analysis subscription request according to embodiments of the present disclosure.

As shown in FIG. 12, when the terminal initiates the analysis subscription request, if a base station currently accessed by the terminal is a gNB, the analysis subscription request may be sent to the gNB. The gNB may determine the target model for data analysis according to the content to be analyzed for the analysis subscription request, and then query whether the target model exists locally.

If the target model exists locally, the data analysis can be performed directly through the target model to obtain an analysis result. If the target model does not exist locally, the analysis subscription request may be sent to the OAM, and the OAM may determine the target model for the data analysis according to the content to be analyzed for the analysis subscription request, and then send the target model to the gNB.

In order to perform the data analysis, the gNB may obtain data from other base stations as the input of the target model. For example, the gNB may send a data acquisition request to the terminal and other gNBs and other ng-eNBs in the network. The terminal and other base stations may send the data required by the gNB to the gNB. The process includes operations like that the gNB collects data, other base stations report data to the gNB, and the gNB preprocesses the data, etc.

Furthermore, the gNB may input the obtained data into the target model to obtain an analysis result, and send the analysis result to the terminal. The terminal may perform a corresponding strategy adjustment according to the analysis result. For example, the content to be analyzed for the analysis subscription request is to determine a target base station suitable for the terminal to be handed over to, and the target base station may be determined according to the analysis result, then the strategy adjustment to be performed may be that the terminal hands over to the target base station.

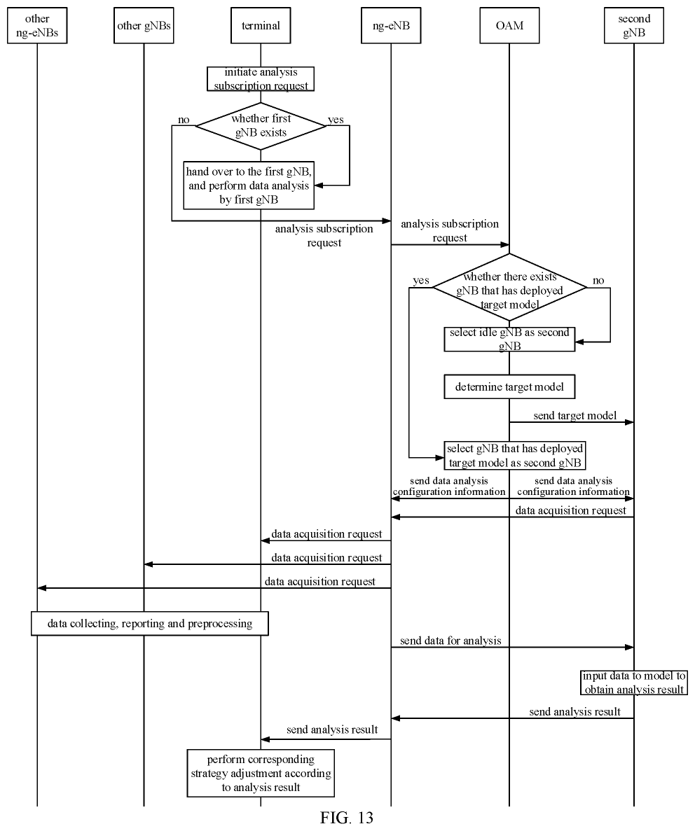

FIG. 13 is a schematic diagram showing interactions when a terminal initiates an analysis subscription request according to embodiments of the present disclosure.

As shown in FIG. 13, when the terminal initiates the analysis subscription request, if a base station currently accessed by the terminal is an ng-eNB, since the ng-eNB is not capable of performing data analysis according to a model, the terminal may determine whether there exists a first gNB accessible. For example, the signal strength of 5G signals is detected, and a base station corresponding to a 5G signal with a signal strength greater than a strength threshold is used as the first gNB.

If there exists the first gNB accessible, the terminal may hand over to the first gNB, and send the analysis subscription request to the first gNB. The first gNB will perform the data analysis. The analysis process is basically the same as that performed by the gNB as described above, which will not be elaborated here.

If there is no first gNB accessible, the analysis subscription request may be sent to an OAM via the currently accessed ng-eNB, and the analysis subscription request may be directly sent to the OAM by the ng-eNB, or may be sent to the OAM via a gNB adjacent to the ng-eN.

After receiving the analysis subscription request, the OAM may determine the target model for data analysis according to the content to be analyzed for the analysis subscription request, and then determine whether there exists a gNB that has deployed the target model.

If there is no gNB that has deployed the target model, an idle gNB may be selected as the second gNB, and the target model may be sent to the second gNB. If there exists the gNB that has deployed the target model, the gNB may be directly used as the second gNB. Further, the OAM may send data analysis configuration information to both the ng-eNB and the second gNB, to indicate that the data analysis will be performed by the second gNB subsequently.

In order to perform the data analysis, the second gNB may obtain data from the terminal and other base stations in the network as the input of the target model. For example, the second gNB may send a data acquisition request to the terminal, the ng-eNB currently accessed by the terminal, other gNBs and other ng-eNB in the network, and these base stations and the terminal may send data required by the second gNB to the second gNB. This process includes operations like that the second gNB collects data, the terminal and the base station report data to the second gNB, and the second gNB preprocesses the data.

Furthermore, the second gNB may input the obtained data into the target model to obtain an analysis result, and send the analysis result to the terminal via the ng-eNB. The terminal may perform a corresponding strategy adjustment according to the analysis result. For example, the content to be analyzed for the analysis subscription request is to determine a target base station suitable for the terminal to be handed over to, and the target base station may be determined according to the analysis result, then the strategy adjustment to be performed may be that the terminal hands over to the target base station.

Corresponding to the aforementioned embodiments of the methods for sending a request and the methods for determining a base station, the present disclosure also provides embodiments of a device for sending a request and a device for determining a base station.

Embodiments of the present disclosure also provide a device for sending a request, which may be applied to a terminal. The terminal includes, but is not limited to, a communication device such as a mobile phone, a tablet computer, a wearable device, a sensor, or an Internet of Things device. The terminal may serve as a user equipment to communicate with a base station, and the base station includes, but is not limited to, a 5G base station gNB and an enhanced 4G base station ng-eNB in series 4 of a non-standalone network mode.

In an embodiment, the device includes one or more processors configured to: determine a first gNB accessible, when initiating an analysis subscription request, and in response to a currently accessed base station being an ng-eNB; and hand over to the first gNB, and send the analysis subscription request to the first gNB.

In an embodiment, the one or more processors are configured to: detect a signal strength of a received signal; and determine a base station corresponding to a 5G signal with a signal strength greater than a strength threshold as the first gNB.

In an embodiment, the one or more processors are further configured to: request an operation administration and maintenance (OAM) to determine a second gNB that is capable of performing data analysis for the analysis subscription request, if no 5G signal with a signal strength greater than a strength threshold is detected; and send the analysis subscription request to the second gNB.

In an embodiment, the one or more processors are further configured to: send the analysis subscription request to a gNB in an NE-DC when the currently accessed base station is the gNB in the NE-DC.

Embodiments of the present disclosure also provide a device for determining a base station, which may be applied to an OAM. The OAM may communicate with a base station in a network, such as a gNB and an ng-eNB in an NE-DC, and the base station may communicate with a terminal. The terminal includes, but is not limited to, a communication device such as a mobile phone, a tablet computer, a wearable device, a sensor, or an Internet of Things device, and the base station includes, but is not limited to, a 5G base station gNB and an enhanced 4G base station ng-eNB in series 4 of a non-standalone network mode.

In an embodiment, the device includes one or more processors configured to: receive an analysis subscription request sent by an ng-eNB, and determine a second gNB capable of performing data analysis for the analysis subscription request; determine the second gNB; and send data analysis configuration information to the second gNB and the ng-eNB. The data analysis configuration information is used to indicate that an analysis result for the analysis subscription request is to be sent by the second gNB to the ng-eNB.

In an embodiment, the one or more processors are configured to: determine whether a target gNB assigned with a target model exists; and determine the target gNB as the second gNB when the target gNB exists. The target model is applicable to perform data analysis for the analysis subscription request.

In an embodiment, the one or more processors are further configured to: determine an idle gNB as the second gNB when the target gNB does not exist; and send the target model to the second gNB.

In an embodiment, the analysis subscription request is initiated by the ng-eNB, or initiated by a terminal accessing the ng-eNB and sent to the ng-eNB.

Embodiments of the present disclosure also provide a device for sending a request, which may be applied to a base station ng-eNB in an NE-DC, and the ng-eNB may communicate with a terminal and an OAM. The terminal includes, but is not limited to, a communication device such as a mobile phone, a tablet computer, a wearable device, a sensor, or an Internet of Things device.

In an embodiment, the device includes one or more processors configured to: send an analysis subscription request to an OAM when initiating the analysis subscription request or receiving the analysis subscription request from a terminal, to request the OAM to determine a second gNB capable of performing data analysis for the analysis subscription request; and receive an analysis result for the analysis subscription request sent by the second gNB.

In an embodiment, the one or more processors are further configured to: receive data analysis configuration information sent by the OAM, before receiving the analysis result for the analysis subscription request sent by the second gNB; and determine according to the data analysis configuration information that the analysis result for the analysis subscription request is to be sent by the second gNB to the ng-eNB.

In an embodiment, the one or more processors are further configured to: receive a model inference data request sent by the second gNB, where the model inference data request is used to request to obtain data for performing the data analysis for the analysis subscription request from the ng-eNB; and send the data for performing the data analysis for the analysis subscription request to the second gNB.

With respect to the devices in the above embodiments, the specific manners for performing operations of individual modules therein have been described in detail in embodiments of the related methods, which will not be elaborated here.

For the device embodiments, since they substantially correspond to the method embodiments, for the relevant parts, reference may be made to the descriptions of the method embodiments. The above-described device embodiments are merely for the purpose of illustration, in which modules described as separate components may be or may not be physically separated, and components shown as modules may be or may not be physical modules, that is, either located at one place or distributed onto a plurality of network modules. The objects of embodiments of the present disclosure may be achieved by some or all of the modules in accordance with practical requirements. It would be appreciated and executable by those skilled in the art without creative efforts.

Embodiments of the present disclosure also provide a communication device, which includes: a processor; and a memory for storing a computer program. When the computer program is executed by the processor, the method for sending a request performed by a terminal as described in any embodiment above is implemented.

Embodiments of the present disclosure also provide a communication device, which includes: a processor; and a memory for storing a computer program. When the computer program is executed by the processor, the method for determining a base station as described in any embodiment above is implemented.

Embodiments of the present disclosure also provide a communication device, which includes: a processor; and a memory for storing a computer program. When the computer program is executed by the processor, the method for sending a request performed by an ng-eNB as described in any embodiment above is implemented.

Embodiments of the present disclosure also provide a non-transitory computer-readable storage medium having stored therein a computer program that, when executed by a processor, causes steps in the method for sending a request performed by a terminal as described in any embodiment above to be implemented.

Embodiments of the present disclosure also provide a non-transitory computer-readable storage medium having stored therein a computer program that, when executed by a processor, causes steps in the method for determining a base station as described in any embodiment above to be implemented.

Embodiments of the present disclosure also provide a non-transitory computer-readable storage medium having stored therein a computer program that, when executed by a processor, causes steps in the method for sending a request performed by an ng-eNB as described in any embodiment above to be implemented.

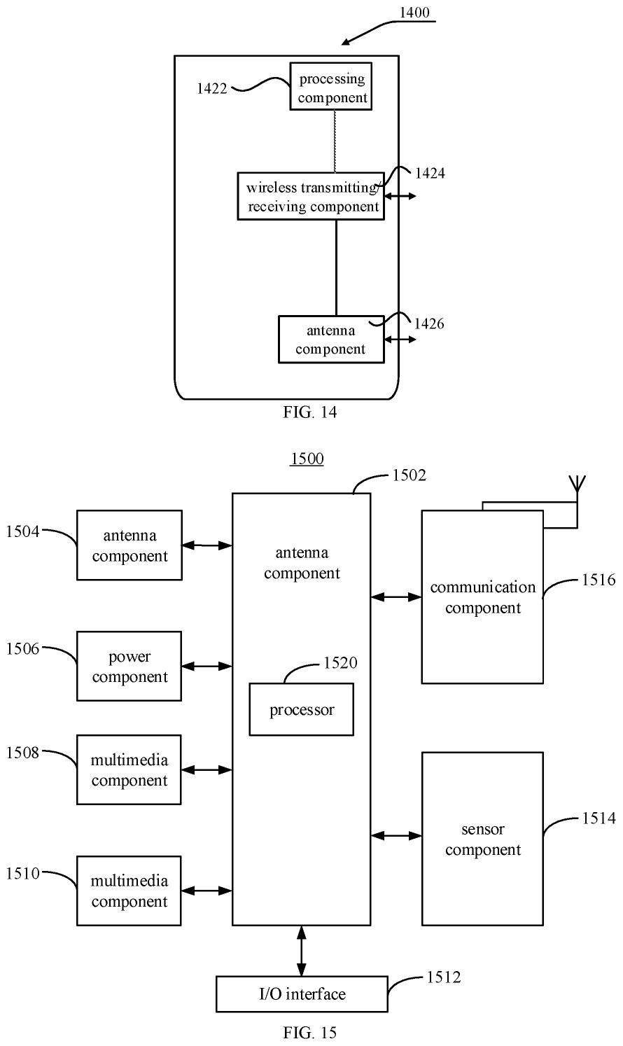

FIG. 14 is a schematic block diagram showing a device 1400 for sending a request according to embodiments of the present disclosure. As shown in FIG. 14, the device 1400 may be provided as a base station. Referring to FIG. 14, the device 1400 includes a processing component 1422, a wireless transmitting/receiving component 1424, an antenna component 1426, and a signal processing part specific to a wireless interface. The processing component 1422 may further include one or more processors. One of the processors in the processing component 1422 may be configured to implement the method for sending a request performed by an ng-eNB as described above.

FIG. 15 is a schematic block diagram showing a device 1500 for sending a request according to embodiments of the present disclosure. For example, the device 1500 may be a mobile phone, a computer, a digital broadcast terminal, a messaging device, a game console, a tablet device, a medical device, a fitness device, a personal digital assistant, or the like.

Referring to FIG. 15, the device 1500 may include one or more of the following components: a processing component 1502, a memory 1504, a power component 1506, a multimedia component 1508, an audio component 1510, an input/output (I/O) interface 1512, a sensor component 1514, and a communication component 1516.

The processing component 1502 typically controls overall operations of the device 1500, such as the operations associated with display, phone calls, data communication, camera operations, and recording operations. The processing component 1502 can include one or more processors 1520 to execute instructions to perform all or some of the steps in the above-described method for sending a request performed by a terminal. Moreover, the processing component 1502 may include one or more modules which facilitate the interaction between the processing component 1502 and other components. For instance, the processing component 1502 may include a multimedia module to facilitate the interaction between the multimedia component 1508 and the processing component 1502.

The memory 1504 is configured to store various types of data to support the operation of the device 1500. Examples of such data include instructions for any applications or methods operated on the device 1500, contact data, phonebook data, messages, pictures, videos, etc. The memory 1504 may be implemented using any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1506 provides power to various components of the device 1500. The power component 1506 may include a power management system, one or more power sources, and any other components associated with the generation, management, and distribution of power in the device 1500.

The multimedia component 1508 includes a screen providing an output interface between the device 1500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1508 includes a front camera and/or a rear camera. The front camera and/or the rear camera may receive an external multimedia datum while the device 1500 is in an operation mode, such as a photographing mode or a video mode. Each of the front camera and the rear camera may be a fixed optical lens system or have focus and optical zoom capability.

The audio component 1510 is configured to output and/or input audio signals. For example, the audio component 1510 includes a microphone (MIC) configured to receive an external audio signal when the device 1500 is in an operation mode, such as a call mode, a recording mode, and a voice recognition mode. The received audio signal may be further stored in the memory 1504 or transmitted via the communication component 1516. In some embodiments, the audio component 1510 further includes a speaker to output audio signals.

The I/O interface 1512 provides an interface between the processing component 1502 and peripheral interface modules, such as keyboards, click wheels, buttons, and the like. The buttons may include, but are not limited to, a home button, a volume button, a starting button, and a locking button.

The sensor component 1514 includes one or more sensors to provide status assessments of various aspects of the device 1500. For instance, the sensor component 1514 may detect an open/closed status of the device 1500, relative positioning of components, e.g., the display and the keypad, of the device 1500, a change in position of the device 1500 or a component of the device 1500, a presence or absence of user contact with the device 1500, an orientation or an acceleration/deceleration of the device 1500, and a change in temperature of the device 1500. The sensor component 1514 may include a proximity sensor configured to detect the presence of nearby objects without any physical contact. The sensor component 1514 may further include a light sensor, such as a CMOS or CCD image sensor, for use in imaging applications. In some embodiments, the sensor component 1514 may further include an accelerometer sensor, a gyroscope sensor, a magnetic sensor, a pressure sensor, or a temperature sensor.

The communication component 1516 is configured to facilitate communication, wired or wireless, between the device 1500 and other devices. The device 1500 can access a wireless network based on a communication standard, such as Wi-Fi, 2G, 3G, 4G LTE, 5G NR, or a combination thereof. In an illustrative embodiment, the communication component 1516 receives a broadcast signal or broadcast associated information from an external broadcast management system via a broadcast channel. In an illustrative embodiment, the communication component 1516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an illustrative embodiment, the device 1500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements, for performing the method for sending a request performed by a terminal as described above.

In an illustrative embodiment, there is also provided a non-transitory computer readable storage medium including instructions, such as included in the memory 1504, executable by the processor 1520 in the device 1500, for completing the method for sending a request performed by a terminal as described above. For example, the non-transitory computer-readable storage medium may be a ROM, a random-access memory (RAM), a CD-ROM, a magnetic tape, a floppy disc, an optical data storage device, and the like. Other embodiments of the present disclosure will be apparent to those skilled in the art from consideration of the specification and practice of the disclosure disclosed here. The present disclosure is intended to cover any variations, uses, or adaptations of the present disclosure following the general principles thereof and including such departures from the present disclosure as come within known or customary practice in the art. It is intended that the specification and examples be considered as illustrative only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

It is to be noted that in this context, relational terms such as first and second are used solely to distinguish one entity or operation from another entity or operation, it does not necessarily require or imply any such actual relationship or sequence between these entities or operations. The term “include,” “comprise” or any other variation thereof is intended to cover a non-exclusive inclusion, so that a process, method, article or device that includes a series of elements does not only include those elements, but also includes other elements that are not explicitly listed, or also includes elements inherent in such a process, method, article or device. Without further restrictions, an element defined by the statement “including a . . . ” does not exclude the existence of another identical element in the process, method, article or device that includes the element.

The methods and devices provided by embodiments of the present disclosure have been described in detail above, and specific examples are used to illustrate the principle and implementation of the present disclosure. The description of the above embodiments is only used to help understand the methods and core ideas of the present disclosure. At the same time, for those skilled in the art, there will be some changes in the specific implementation and application scope according to the idea of the present disclosure. In summary, the content of the specification should not be construed as a limitation on the present disclosure.

1. A method for sending a request, performed by a terminal, comprising:
determining a first next generation node B (gNB) accessible, when initiating an analysis subscription request, and in response to a currently accessed base station being a next generation eNodeB (ng-eNB); and
handing over to the first gNB, and sending the analysis subscription request to the first gNB.

2. The method according to claim 1, wherein determining the first gNB accessible comprises:
detecting a signal strength of a received signal; and
determining a base station corresponding to a 5th generation (5G) signal with a signal strength greater than a strength threshold as the first gNB.

3. The method according to claim 1, further comprising:
requesting an operation administration and maintenance (OAM) to determine a second gNB that is configured to perform data analysis for the analysis subscription request, in response to not detecting a 5th generation (5G) signal with a signal strength greater than a strength threshold; and
sending the analysis subscription request to the second gNB.

4. The method according to claim 1, further comprising:
sending the analysis subscription request to a gNB in a New Radio (NR) eNB dual connection (NE-DC) when the currently accessed base station is the gNB in the NE-DC.

5. A method for determining a base station, performed by an operation administration and maintenance (OAM), comprising:
receiving an analysis subscription request sent by a next generation eNodeB (ng-eNB), and determining a next generation node B (gNB) configured to perform data analysis for the analysis subscription request;
determining the gNB; and
sending data analysis configuration information to the gNB and the ng-eNB, wherein the data analysis configuration information is used to indicate that an analysis result for the analysis subscription request is to be sent by the gNB to the ng-eNB.

6. The method according to claim 5, wherein determining the gNB comprises:
determining whether a target gNB assigned with a target model exists, wherein the target model is applicable to perform data analysis for the analysis subscription request; and
determining the target gNB as the gNB when the target gNB exists.

7. The method according to claim 6, further comprising:
determining an idle gNB as the gNB when the target gNB does not exist; and
sending the target model to the gNB.

8. The method according to claim 5, wherein the analysis subscription request is initiated by the ng-eNB, or initiated by a terminal accessing the ng-eNB and sent to the ng-eNB.

9. A method for sending a request, performed by a next generation eNodeB (ng-eNB), comprising:
sending an analysis subscription request to an operation administration and maintenance (OAM) when initiating the analysis subscription request or receiving the analysis subscription request from a terminal, to request the OAM to determine a next generation node B (gNB) configured to perform data analysis for the analysis subscription request; and
receiving an analysis result for the analysis subscription request sent by the gNB.

10. The method according to claim 9, wherein before receiving the analysis result for the analysis subscription request sent by the gNB, the method further comprises:
receiving data analysis configuration information sent by the OAM; and
determining according to the data analysis configuration information that the analysis result for the analysis subscription request is to be sent by the gNB to the ng-eNB.

11. The method according to claim 10, further comprising:
receiving a model inference data request sent by the gNB, wherein the model inference data request is used to request to obtain data for performing the data analysis for the analysis subscription request from the ng-eNB; and
sending the data for performing the data analysis for the analysis subscription request to the gNB.

12. A device for sending a request, comprising:
one or more processors, configured to perform the method according to claim 1.

13. A device for determining a base station, comprising:
one or more processors, configured to perform the method according to claim 5.

14. A device for sending a request, comprising:
one or more processors, configured to perform the method according to claim 9.

15. A communication device, comprising:
a processor; and
a memory for storing a computer program;
wherein when the computer program is executed by the processor, the method for sending the request according to claim 1 is implemented.

16. A communication device, comprising:
a processor; and
a memory for storing a computer program;
wherein when the computer program is executed by the processor, the method for determining the base station according to claim 5 is implemented.

17. A communication device, comprising:
a processor; and
a memory for storing a computer program;
wherein when the computer program is executed by the processor, the method for sending the request according to claim 9 is implemented.

18. A non-transitory computer-readable storage medium having stored therein a computer program that, when executed by a processor, causes act in the method for sending the request according to claim 1 to be performed.

19. A non-transitory computer-readable storage medium having stored therein a computer program that, when executed by a processor, causes act in the method for determining the base station according to claim 5 to be performed.

20. A non-transitory computer-readable storage medium having stored therein a computer program that, when executed by a processor, causes act in the method for sending the request according to claim 9 to be perform.
